(19) United States
(12) Patent Application Publication
(10) Pub. No.: US 2002/0080795 A1
(43) Pub. Date: Jun. 27, 2002

(54) Packet switching arrangement comprising a cascade control and bufferless cascade switching matrix

(76) Inventors: Andries Van Wageningen, Wijlre (NL); Hans-Juergen Reumermann, Aachen (DE); Armand Lelkens, Klimmen (NL)

Correspondence Address: Philips Electronics North America Corporation, 580 White Plains Road, Tarrytown, NY, 10591, US

(21) Appl. No.: 09/996,002

(22) Filed: Nov. 16, 2001

(30) Foreign Application Priority Data
Nov. 18, 2000 (DE) 10057343.6

(51) Int. Cl. H04L 12/56

(52) U.S. Cl. 370/395.3; 370/412

(57) ABSTRACT

The invention relates to a packet switching arrangement comprising a switching network of a plurality of bufferless switching matrices (6) and a plurality of cascade switch controls (7) assigned to one switching matrix (6) each, which switch controls (7) respectively include

an identification analyzer (12) for identifying the input port in a route identification assigned to a packet,

an output allocator (13) for evaluating the route identification,

a configuration unit (14) for storing accepted assignments of a respective input port to an output port,

an identification assignment analyzer (15) for changing and guiding the route identification to a port control (2 to 5).

The invention relates to a packet switching arrangement comprising a switching network.

In the publication “Weighted Arbitration Algorithms with Priorities for Input-Queued Switches with 100% Throughput” by R. Schoenen, G. Post, G. Sander, Broadband Switching Symposium 1999, various weighted switching algorithms of a packet switching arrangement are compared. The switching algorithms try to avoid a collision of a plurality of packets intended for the same output port of the packet switching arrangement by different switching steps, and to reduce resultant data loss or delay.

It is an object of the invention to guarantee a collisionless exchange of data in the form of packets.

The object is achieved by a packet switching arrangement comprising a switching network of a plurality of bufferless switching matrices and a plurality of cascade switch controls assigned to a respective switching matrix, which switch controls each include at least

an identification analyzer for identifying the input port in a route identification assigned to a packet,

an output allocator for evaluating the route identification,

a configuration unit for storing accepted assignments of a respective input port to an output port,

an identification assignment analyzer for changing and conveying the route identification to a port controller.

A packet switching arrangement switches the signaling and useful data received as packets on the input port to the respective output port.

When a route identification is generated for sending the packet through the packet switching arrangement, a port controller responsible for the input port utilizes a table which contains the route and priority information necessary for the route identification. The route and priority information indicates the destination output of the packet switching arrangement and a weight of the request. A weight may contain indications about the priority and class of the packets or the waiting time or size of a queue, respectively.

The packet switching arrangement comprises a plurality of cascade bufferless switching matrices for combining input ports and output ports, a plurality of cascade switch controls for initializing and changing the configuration of the switching matrices and several registers in the form of logic queues, working according to the FIFO method (First In First Out).

The interface between the port controller and the packet switching arrangement may comprise either two separate lines for signaling data and useful data, or a part of the port controller is integrated with the packet switching arrangement, and the signaling data and useful data are transmitted in common over a line in a multiplex mode (in-band control).

When a bufferless switching matrix is used, a collision of a plurality of packets intended for the same output port leads to a loss of packets. To avoid the loss, the packets are buffered in queues in the port controller. Since cells of constant length are easier to maintain during the switching than packets of changing size, the incoming packets are subdivided into cells of constant length. After a successful switching i.e. accepted assignment of a respective input port to an output port, the cells are removed from the queue.

A cell may either be sent simultaneously with the route identification to the packet switching arrangement, or the cell is conveyed separately to the packet switching arrangement after the route identification has arrived with a request at the packet switching arrangement some time before that, and this packet switching arrangement has made its preparation for the transfer of the cell.

The simultaneous transmission of route identification and cell is referred to as self-routing. It has the disadvantage that in the port controller a decision is made which cell is switched and, therefore, a collision of the cells cannot be avoided. By sending the route identification and the cell separately, the loss owing to a cell collision cannot in essence be reduced. A further possibility is to lead the route identification with several requests to the packet switching arrangement, and this packet switching arrangement decides which of the requests is accepted and then starts preparing the transfer of the selected cell. This possibility offers a switching of cells almost without any losses.

To enhance the capacity of the packet switching arrangement, a plurality of switching matrices are operated in parallel and simultaneously connected in series, so that a cascading of the individual switching matrix evolves. The switching matrices connected to a cascade are individually controlled by a switch control and together form a switching matrix of appropriate size.

For configuring the large switching matrix, an algorithm distributed over the switch controls is used. Since each switch control utilizes an algorithm to configure the associated switching matrix, the cascading of the results can make a rough decision of the packet switching arrangement.

The route identification coming from the port controller is transferred to all the switch controls via a request (which switch controls are stated in one row of the cascade). The signal is conveyed from each switch control to the next and refreshed in each switch control. The switch controls located in one row of the cascade are each responsible for one output port. Each of the cascaded (in a column) switch controls decides on the basis of the weight between the result locally achieved in the switch control and the result coming from the predecessor (lying in the same column). The decision is announced to the successor (located in the same column).

The results of the switch controls in the bottom row of a cascade are the resulting switchings for the output ports. Since the switch controls decide on one output, there may be various different results for one input port. To make a decision for the input ports, the results are sent back to the switch controls.

The decision for the input ports is made in similar fashion to the decision for the output ports. The results of the switch controls in the bottom row of a cascade are then the resulting switchings for the input ports. These results, which form a sub-set of the results for the output ports, are at the same time also the resulting switchings for the switching matrix. To improve the result, the operation described above can be iteratively repeated for the inputs that have not yet been switched.

These and other aspects of the invention are apparent from and will be elucidated with reference to the embodiments described hereinafter.

### IN THE DRAWINGS

FIG. 1 gives a representation of a packet switching arrangement with separate inputs of the signaling and useful data,

FIG. 2 gives a representation of a packet switching arrangement having inputs for signaling and useful data multiplexed collectively (in-band control),

FIG. 3 gives a basic diagram of a switching of cells via route identifications in a packet switching arrangement, which are sent collectively or separately,

FIG. 4 shows a basic diagram of a switching based on a plurality of simultaneously received route identification requests in a packet switching arrangement,

FIG. 5 shows a basic diagram of a plurality of iteratively determined switchings based on a plurality of simultaneously received route identification requests in a packet switching arrangement,

FIG. 6 shows a basic diagram of an iteratively determined switching by a plurality of cascaded switch controls, and

FIG. 7 shows a large switching matrix comprising a cascade of a plurality of switching matrices with a plurality of cascaded switch controls.

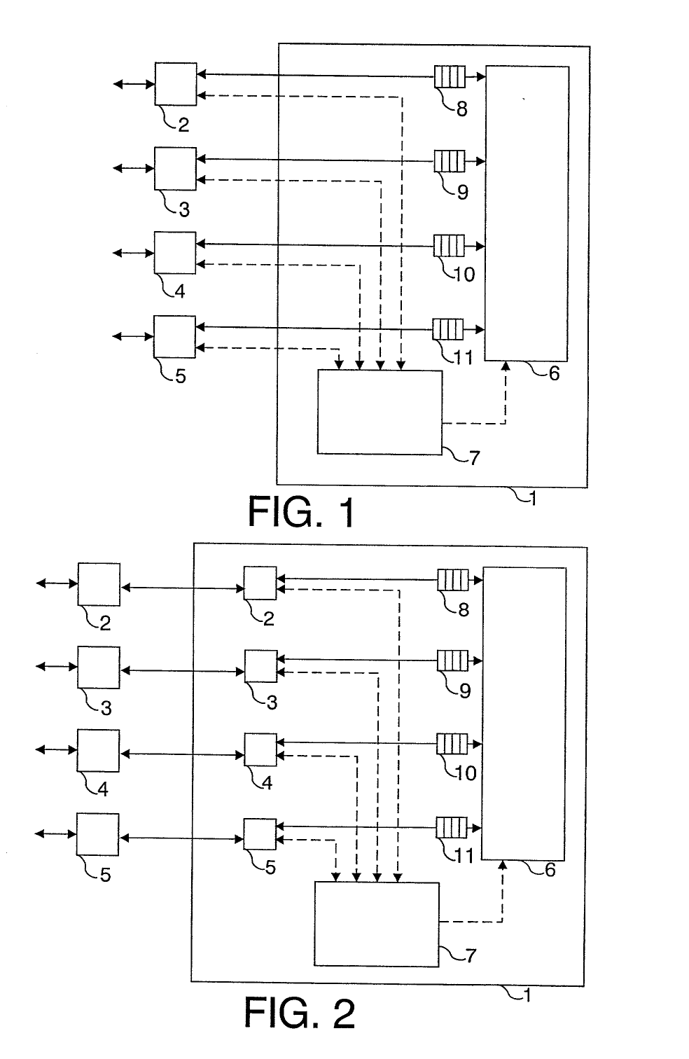

The packet switching arrangement 1 shown in FIG. 1 for the packet data transport connects a certain number of input ports to the respective output ports. For the packets arriving at the input port, information such as, for example, a route and a priority is determined by a respective port controller 2 to 5 on the basis of switching tables. The next step for the switching of the packets subdivided into cells comprises conveying them to the predetermined output line of the packet switching arrangement 1. The switching steps required for this purpose are explained in the following.

The packet switching arrangement 1 comprises a switching matrix 6, a switch control 7 and several registers 8 to 11 in the form of logic queues and working according to the FIFO method (First In First Out).

An alternative representation of the packet switching arrangement 1 is further described with reference to FIG. 2. Different from the packet switching arrangement 1 shown in FIG. 1, the port controller 2 to 5 is split up into two parts, of which one part of the port controller 2 to 5 is integrated with the packet switching arrangement (for in-band control). As a result, no separate links of the signaling and useful data are developed at the interface between the first part of the port controller 2 to 5 and the packet switching arrangement 1, but a link over which the signaling data and useful data are collectively multiplexed and transmitted to the packet switching arrangement 1.

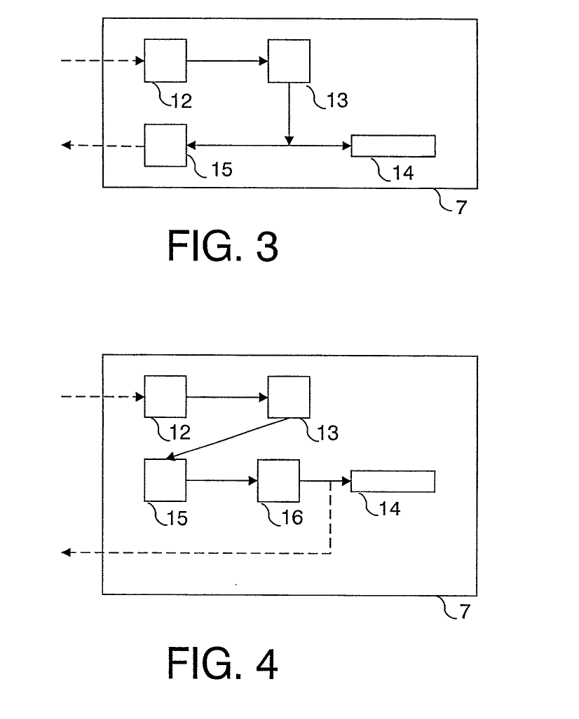

The function of the packet switching arrangement 1 shown in FIGS. 1 and 2 will be further explained with the aid of the diagrams shown in FIGS. 3 to 5.

For transporting cells, the port controller 2 to 5 generates a route identification with information for the destination output of the packet switching arrangement and the weight of the request. A weight may contain details about the priority and class of the packets or the waiting time or size of a queue.

In the following, the function of the packet switching arrangement is described for a combined transmission of the route identification and the cell. The port controller 2 to 5 conveys the cell together with the route identification to the packet switching arrangement 1. Inside the packet switching arrangement the route identification is conveyed to the switch control 7 and the associated cell to the switching matrix where the register 8 to 11 working according to the FIFO method (First In First Out) is inserted.

The switch control 7 shown in FIG. 3 comprises an identification analyzer 12, which replaces the destination output number with an input number, so that the original input of the request can be traced back. The changed route identification is then conveyed to an appropriate output allocator 13.

For each output port is responsible a single output allocator 13 which processes all the requests coming from the identification analyzer 12. Based on the route identification the output allocator 13 decides which one of the requests is accepted. Then the route identification is sent to a configuration unit 14 and an identification assignment analyzer 15.

The configuration unit 14 collects the assigned route identifications of the output allocator 13 and sends them to the configuration registers in the switching matrix 6.

The object of the identification assignment analyzer 15 is to replace the input numbers with the destination output numbers and to convey the changed route identification to the requesting port controller 2 to 5.

After the requesting port controller 2 to 5 has received the changed route identification, the cell belonging to the route identification is removed from the queue and the switching matrix 6 is configured accordingly.

The switching of the cell if route identification and cell are sent separately is also depicted with the aid of FIG. 3.

Different from the switching steps described before, the port controller 2 to 5 in this case only conveys the respective route identification to the switch control 7 and the associated cell remains in the port controller 2 to 5. Analogous with the above-described processing steps, the route identification is changed by the identification analyzer 12, the output allocator 13, configuration unit 14 and the identification assignment analyzer 15. After the requesting port controller 2 to 5 has received the changed route identification, first the cell is sent to the switching matrix 6 at this instant and, subsequently, removed from the queue.

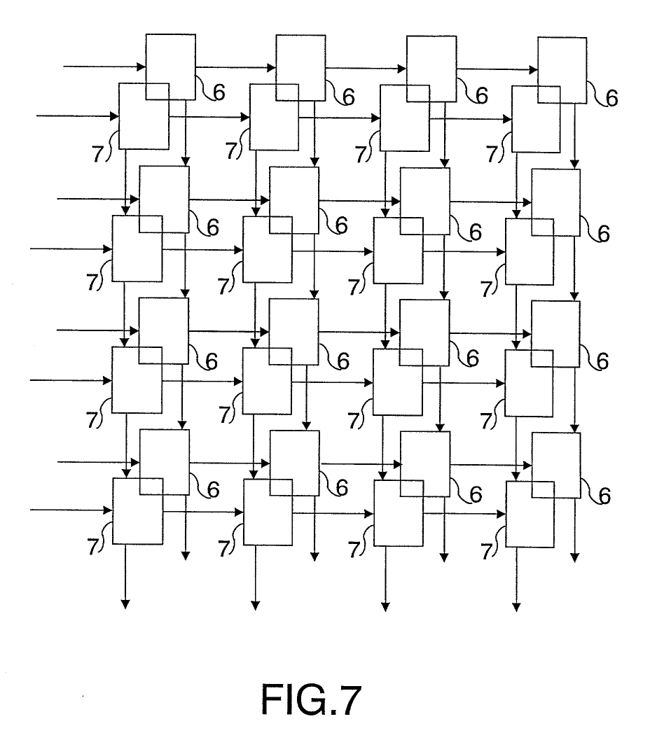

The simultaneous processing of various switch requests within a switching of the switch control 7 is explained with reference to FIG. 7.

The port controller 2 to 5 generates the route identification which contains all the destination output numbers of the packet switching arrangement, various requests and their weights.

This route identification is transferred to the switch control 7 while the cells of the port controller 2 to 5 stay and are switched at a later instant.

Inside the switch control 7 the route identification arrives at the identification analyzer 12 which replaces the destination output numbers with input numbers, so that the original input of the requests can be traced back. Each change of the route identification is then conveyed to the responsible output allocator 13.

For each output port is responsible a single output allocator 13 which processes all the requests coming from the identification analyzer 12. Based on the weight of the route identification, the output allocator 13 decides which one of the requests is accepted. The accepted route identification is conveyed to the identification assignment analyzer 15.

The identification assignment analyzer 15 replaces the input numbers with the destination output numbers and conveys the changed route identification to a responsible input allocator 16.

For each input port is responsible a single input allocator 16 which processes all the allocations coming from the identification assignment analyzer 15. Based on the weight of the route identification, the input allocator 16 decides which one of the allocations is accepted. The accepted allocation is announced to the configuration unit 14 and to the requesting port controller 2 to 5.

The configuration unit 14 is collectively supplied with the assigned route identifications before the configuration unit 14 sends them to the configuration registers in the switching matrix 6. In the next step the switching matrix 6 is reconfigured accordingly to transmit the cells.

After the requesting port controller 2 to 5 has received the changed route identification, first the cells are sent to the switching matrix 6 at this instant and thereafter removed from the queue.

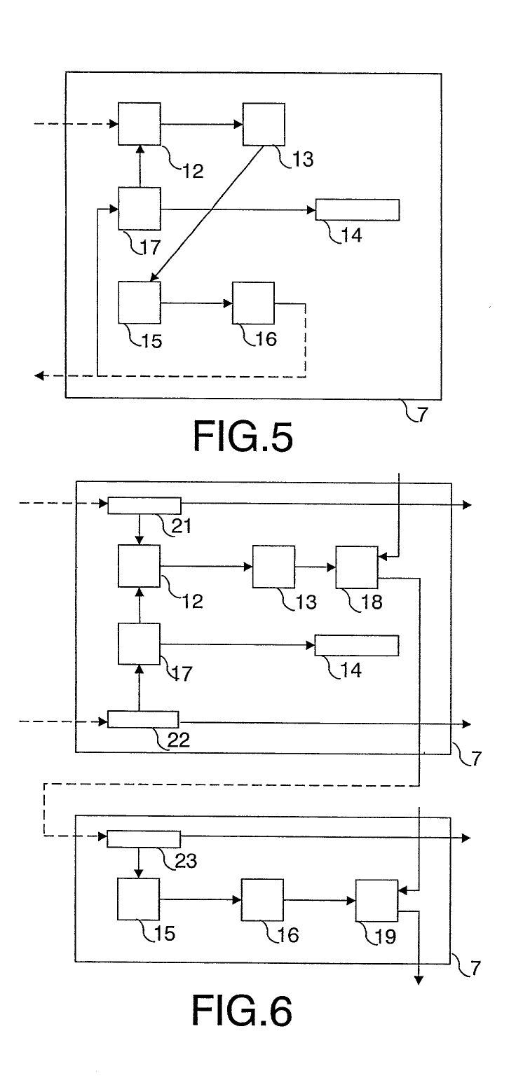

The processing of a plurality of switching requests simultaneously with a plurality of iterative switching steps of the switch control 7 is explained with reference to FIG. 5.

The port controller 2 to 5 generates the route identification which contains all the destination output numbers of the packet switching arrangement of various requests and their weights. This route identification is transferred to the switch control 7, while the cells stay in the port controller 2 to 5 and are switched at a later instant.

Inside the switch control 7 the identification analyzer 12 stores the route identifications to utilize them at a later instant for the execution of iterative switching steps, and replaces the destination output numbers with input numbers, so that the original input of the requests can be traced back.

The following switching steps are repeated iteratively:

The requests processed in the previously executed iterative switching steps i.e. the combinations already assigned between the inputs and outputs of the packet switching arrangement are stored by the identification analyzer 12. The changed part of the route identification for all non-switched inputs is transferred to the responsible output allocator 13.

For each output port is responsible a single output allocator 13, which processes all the requests coming from the identification analyzer 12. Based on the weight of the route identification, the output allocator 13 decides which one of the requests is accepted. The selected route identification is transferred to the identification assignment analyzer 15.

The identification assignment analyzer 15 replaces the input number with the destination output number and hands over the changed route identification to the respective input allocator 16.

For each input port is responsible a single input allocator 16 which processes all the allocations coming from the identification assignment analyzer 15. Based on the weight of the route identification, the input allocator 16 decides which one of the allocations is accepted. The selected allocation is announced to a result analyzer 17, the configuration unit 14 and the requesting port controller 2 to 5. The result analyzer 17 informs the identification analyzer 12 of the accepted allocations.

The assigned route identifications of the result analyzer 17 are collectively transferred to the configuration unit 14 before the configuration unit 14 sends them to the configuration registers of the switching matrix 6. In the next step the switch control 7 is reconfigured accordingly to transmit the cells. After the requesting port controller 2 to 5 has received the changed route identification, first the cells are sent to the switching matrix 6 and then removed from the queue.

FIG. 6 describes the iterative switching steps of the cascaded switch controls 7 and switching matrices 6.

The port controller 2 to 5 generates the route identification which contains all the destination output numbers of the packet switching arrangement of various requests and their weights.

This route identification is conveyed to the switch control 7 while the cells stay in the port controller 2 to 5 and are switched at a later instant.

In the switch control 7 the identification analyzer 12 stores the route identification signals refreshed by a refresh 21 to utilize them at a later instant when iterative switching steps are executed, and replaces the destination output numbers with input numbers so that the original input of the requests can be traced back. At the same time, the refreshed signals are conveyed to a next connected switch control 7.

The following switching steps are repeated iteratively

The requests processed in the previously executed iterative switching steps i.e. the combinations already assigned between the inputs and outputs of the packet switching arrangement are stored by the identification analyzer 12. The changed part of the route identification for all non-switched inputs is transferred to the respective output allocator 13.

For each output port is responsible a single output allocator 13, which processes all the requests coming from the identification analyzer 12. Based on the weight of the route identification, the output allocator 13 decides which one of the requests is accepted. The selected route identification is transferred to a request cascade 18.

The request cascade 18 compares the result of the preceding switch control with the result locally coming from the output allocator 13. Based on the weight of the route identification the request cascade 18 decides what parts of the two results are conveyed to the next switch control 7. At the output of the last switch control 7 the signal is fed back to a switch control 7.

Inside the switch control 7 the signal of the result refreshed by a refresh 23 is applied to the identification assignment analyzer 15 and at the same time fed back to a next connected switch control 7.

The identification assignment analyzer 15 replaces the input number with the destination output number and hands over the changed route identification to the responsible input allocator 16.

For each input port is responsible a single input allocator 16 which processes all the allocations coming from the identification assignment analyzer 15. Based on the weight of the route identification, the input allocator 16 decides which one of the allocations is accepted. The selected allocation is applied to an assignment cascade 19.

The assignment cascader 19 compares the result of the preceding switch control 7 with the result locally obtained by the input allocator 16 (accepted allocation). Based on the weight of the route identification, the assignment cascader 19 decides for each input port what parts of the two results are to be transferred to the next switch control 7. At the output of the last switch control 7 the result is announced to the requesting port controller 2 to 5.

The port controller 2 to 5 sends the signal of the outcoming results refreshed by a refresh 22 to the result analyzer 17 of the switch control 7, or the result is immediately transferred from the output of the last switch control 7 to the result analyzer 17 via a refresh 22.

The result analyzer 17 informs the identification analyzer 12 of the accepted allocations (results).

In the configuration unit 14 the assigned route identifications of the result analyzer 17 are gathered before the configuration unit 14 sends them to the configuration registers of the switching matrix 6. Between the current cell period and the next cell period the switching matrix 6 is reconfigured accordingly to transmit the cells in the next cell period. After the requesting port controller 2 to 5 has received the changed route identification, the cells are sent to the switching matrix 6 in the next cell period and thereafter removed from the queue.

FIG. 7 shows the switch controls 7 and switching matrices 6 connected to a cascade. At the inputs leading to the cascade of the switch controls 7 are present the route identifications sent from the port controllers (2 to 5). The results of the bottommost switch controls 7 connected in series are the resulting switchings. If the switch controls come to different results for one input port, the results are fed back to the inputs of the switch controls. The feedback of the results will not be further discussed here.

1. A packet switching arrangement comprising a switching network which includes a plurality of bufferless switching matrices (6) and a plurality of cascaded switch controls (7) assigned each to a switching matrix (6), which switch controls each include at least
an identification analyzer (12) for identifying the input port in a route identification assigned to a packet,
an output allocator (13) for evaluating the route identification,
a configuration unit (14) for storing accepted assignments of a respective input port and an output port,
an identification assignment analyzer (15) for changing and conveying the route identification to a port controller (2 to 5).

2. A packet switching arrangement as claimed in claim 1, characterized in that the switch control (7) includes a plurality of input allocators (16) for evaluating a plurality of requests sent simultaneously with the route identification.

3. A packet switching arrangement as claimed in claim 2, characterized in that the switch control (7) includes at least a result analyzer (17) for informing the identification analyzer (12) of accepted allocations of various requests sent simultaneously with the route identification and of requests iteratively processed by the switch control (7).

4. A packet switching arrangement as claimed in claim 3, characterized in that each switch control (7) includes a request cascader (18) for comparing and selecting a result locally determined by the output allocator (13) and a result achieved by the preceding switch control (7).

5. A packet switching arrangement as claimed in claim 4, characterized in that each switch control (7) includes an assignment cascader (19) for comparing and selecting a result locally determined by the input allocator (16) and a result achieved by the preceding switch control (7).

6. A packet switching arrangement as claimed in claim 1, characterized in that the switching network is connected to a plurality of input ports via multiplexed signaling links and useful data links.
